(19) United States
(12) Patent Application Publication
(10) Pub. No.: US 2006/0147739 A1
(43) Pub. Date: Jul. 6, 2006

(54) Plasma polymerized methyl acrylate as an adhesion layer and moisture barrier organic interlayer for potassium bromide-salt optics

(75) Inventors: Kevin Warner Flanagan, Albany, NY (US); David Corbin Burton, Lady Lake, FL (US)

Correspondence Address: Paul J. Esatto, Jr.;Scully, Scott, Murphy & Presser, 400 Garden City Plaza, Garden City, NY, 11530, US

(73) Assignee: Lockheed Martin Corporation, Bethesda, MD (US)

(21) Appl. No.: 11/028,914

(22) Filed: Jan. 4, 2005

(51) Int. Cl. B32B 27/30; B32B 9/00; H05H 1/24

(52) U.S. Cl. 428/522; 428/696; 428/698; 427/569

(57) ABSTRACT

Disclosed are IR transmissive materials coated with methyl acrylate deposited from a plasma generating process, and method of forming a methyl acrylate film on a surface of an infrared (IR) transmissive material, such as a salt optic. The method includes positioning an IR transmissive material in a reactor chamber of a parallel plate plasma reactor and thereafter depositing a methyl acrylate film on a surface of the IR transmissive material. The depositing is performed at a substrate temperature of about 130° C. or less and in the presence of plasma, which is derived from a gas mixture including a source of methyl acrylate, an inert gas, and optionally hydrogen.

### FIELD OF THE INVENTION

The present invention is directed to the field of optics, more specifically, it is directed to an interlayer coating for a salt optic that exhibits certain improvements in comparison to uncoated salt optics.

### BACKGROUND OF THE INVENTION

The long-wave infrared region is the largest continuous IR transmittance window in the Earth's atmosphere. Military aircraft, for example, use the IR communication window via known communication devices having IR sensors. One of the components involved in IR sensors is a primary lens.

An IR primary lens is an IR transmissive structure. An IR transmissive structure transmits IR energy of wavelengths between about 0.1 microns and 20 microns, preferably between 1 and 15 microns, and most preferably between 2 and 12 microns. One material that exhibits IR transmissive characteristics and is commonly used as an IR lens is germanium. Germanium is a suitable material because it has a singular, or binary crystalline structure that is essentially transparent in the IR spectrum.

The shape of the IR primary lens can be aspheric. The parabolic shape of an aspheric lens is ideal for manipulating the focal point of the IR energy waves. Aspheric germanium lenses are normally manufactured by diamond point turning, a very costly and time consuming process.

Crystalline salt optics, in particular the alkali halide salts such as potassium-bromide, are known to be excellent infrared optical materials. In addition to excellent broadband transmission in the infrared region, alkali halide salts have the added advantage of low refractive index, low dispersion (change in RI with wavelength), low material cost, and widespread availability. Salt optic materials have the potential of exhibiting increased optical transmittance over conventional infrared optical materials, such as silicon, germanium, and other materials. However, applications of salt optics are limited by the materials' hygroscopic nature and susceptibility to degradation when exposed to moisture. For instance, the useful life of the optic may be shortened via exposure to an environment containing an elevated level of moisture, such as an environment with high humidity.

More specifically, most alkali halide salt optics, when left exposed in high-moisture environments (i.e. those of about >30% relative humidity) erode rapidly. This may result in degraded optical performance or failure. Thus, while salt optics transmit infrared wavelengths over a range of about 1 micron to >20 microns, they must presently be employed in moisture controlled environments.

### SUMMARY OF THE INVENTION

The present invention is directed to coated salt optics generally, and more specifically, to a salt optic provided with a novel intermediate layer in a multilayer coating arrangement applied in order to improve upon certain properties exhibited by the uncoated salt optic, such as, for example, improving the moisture resistance of the salt optic. According to the present invention, the salt optic is provided with a coating layer comprised of a methyl acrylate film deposited via a low temperature plasma deposition process. The methyl acrylate film layer exhibits good adhesion to the salt optic substrate, and, in turn, provides a basis for good adhesion of certain second coating layers. In a more specific aspect of the present invention, a second coating layer, such as a barrier layer to moisture, is applied over the methyl acrylate film. Additional layers of coating may form part of the coated salt optic, such as for instance, additional layers of the materials employed first and second coating layer, and/or additional layers of other materials.

In a specific embodiment, the salt optic is a potassium bromide material, or other salt optics such as sodium chloride, potassium chloride, cesium bromide.

In a specific embodiment, the methyl acrylate film is deposited by a plasma deposition process characterized by a low temperature substrate, such as plasma-enhanced chemical vapor deposition (PECVD). In a more specific embodiment, the second coating layer is deposited by a plasma deposition process characterized by a low temperature substrate, such as plasma-enhanced chemical vapor deposition (PECVD). It should be understood that other acrylates can be employed.

The deposition of coatings or films onto substrates via processes employing a plasma comprised of at least one material that is to be deposited are generally known. With regard to plasma deposition processes, it is known that due to the occurrence of certain phenomena such as for example, activation of the starting material in the plasma, fragmentation of the starting material, and rearrangement of the starting material, that the molecular arrangement of the deposited material may differ from the molecular arrangement of the starting material. Such processes have been described a “plasma polymerization”, though where rearrangement is randomized, a repeating unit within the molecular structure of the deposited film may not be present. Furthermore, in certain instances, the deposited structure, on the molecular level, may in certain instances be more properly characterized as macromolecules, as opposed to polymers.

Salt optics, when coated in accordance with the present invention, can be employed in relatively high moisture containing environments, such as high humidity environments. Thus, a salt optic can be produced that can operate in both the visible and infrared portions of the spectrum that can withstand the aforementioned adverse conditions.

### BRIEF DESCRIPTION OF THE DRAWINGS

FIG. 1 is a schematic cross-sectional view of a parallel plate plasma reactor that can be employed in the present invention.

### DETAILED DESCRIPTION OF THE PREFERRED EMBODIMENT

A film of methyl acrylate is deposited via PECVD as the first coating layer in order to provide an organic adhesion layer. The film of methyl acrylate coats the surface of the optic. PECVD deposition of methyl acrylate has been found to provide a good base for the adhesion of subsequently deposited layers. While a capacitively coupled parallel plate RF unit may be used, MW frequency plasma sources, inductively coupled plasma sources, and expanding thermal plasmas are some other examples of plasma sources that can be used for PECVD.

The second coating layer, which for example, may be a moisture barrier layer, provides a barrier between the environment and the salt optic that prevents moisture from reaching the salt optic substrate. Candidates for this layer include but are not limited to: amorphous hydrogenated germanium carbon, and silicon nitride. The barrier layers can be deposited with PECVD, sputtering, e-beam evaporation, sol-gel chemistry, or other physical vapor deposition (PVD), chemical vapor deposition (CVD), or wet chemical coating techniques providing coatings with the desired characteristics. While a capacitively coupled parallel plate RF unit may be used, MW frequency plasma sources, inductively coupled plasma sources, and expanding thermal plasmas are some other examples of plasma sources that can be used for PECVD.

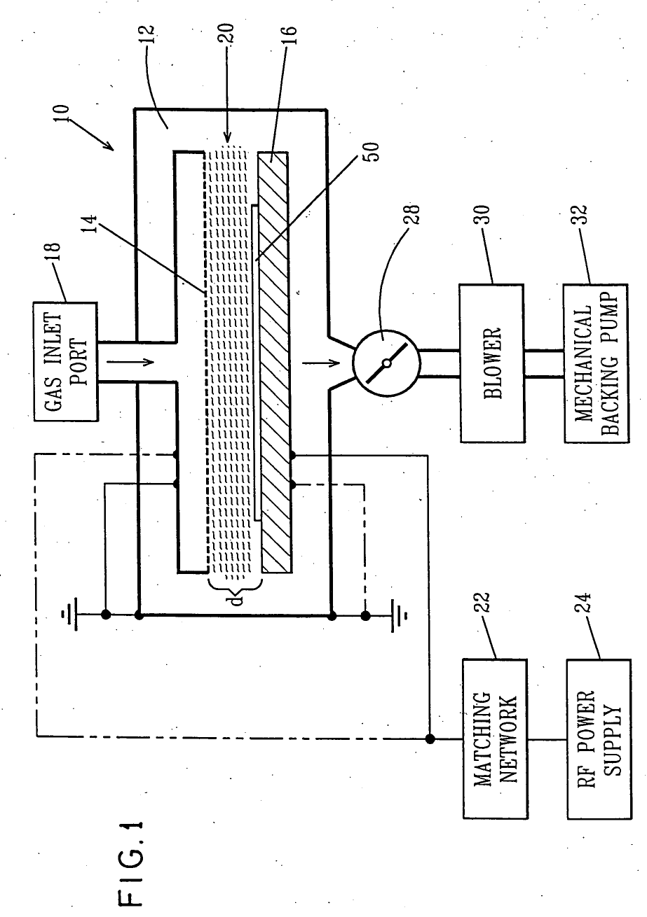

FIG. 1 shows a schematic cross-sectional view of a parallel plate plasma reactor that can be employed in the present invention. Parallel plate plasma reactor 10 includes reactor chamber 12, RF power supply 24, matching network 22, gas inlet port 18, throttle valve 28, blower 30 and mechanical pump 32. Reactor chamber 12 contains the plasma during the deposition process. A RF power supply provides input power for plasma ignition and continuance, while the matching network matches the output impedance of the power supply to the input impedance of the plasma/reactor configuration. The gas inlet port is used to introduce the gas mixture into the reactor chamber. An automated throttle valve maintains the required pressure during deposition. A roots blower and mechanical backing pump are arranged in tandem to provide the necessary vacuum level to allow for low-pressure deposition.

Top (or showerhead) electrode 14 and bottom electrode 16 are positioned inside reactor chamber 12. IR transmissive material 50 may be positioned on either of these electrodes, with the configuration shown in FIG. 1, i.e., IR transmissive material 50 atop bottom electrode 16, being preferred. In accordance with the present invention, the top electrode is separated from the bottom electrode by a distance, d, which is from about 1.00 to about 3.00 inches, with a separation distance of from about 1.25 to about 1.50 inches being preferred. The showerhead electrode includes holes (represented by dotted lines in FIG. 1), which permit gas flow from gas inlet port 18 into reactor chamber 12. The gas exits the reactor chamber when throttle value 28 is switched to an open position. The arrows in the reactor chamber represent the directional flow of the gas mixture.

As shown, the showerhead electrode is coupled to ground, while bottom electrode 16 is connected to RF power source 24. In such an embodiment, the bottom electrode acquires a negative bias, whose value is dependent on the reactor geometry and plasma parameters. Alternatively, the top electrode can be connected to the RF power supply (not shown) and the bottom electrode is coupled to ground. In this alternative embodiment, the top electrode acquires the negative bias. The RF power supply can work continuously throughout the entire deposition process or it can be pulsed during the deposition process.

By preselecting the thickness of each layer in the coating to determine values, and also selecting layer materials with certain refractive indices, anti-reflective coatings and/or protective coatings can be fabricated. This can be used to decrease reflection losses from the surface of the salt optic.

During operation, a region of plasma 20 comprising the gas mixture to be defined herein below is formed between the showerhead electrode and the IR transmissive material. Process variables controlled during the deposition of the methyl acrylate film include RF frequency, reactant gas mixtures and flow rates, pressure in the reactor and substrate temperature. Specifically, the methyl acrylate film of the present invention is deposited using an RF frequency of from about 20 kHz to about 2.45 GHz, with an RF frequency of from about 13.56 MHz to about 2.45 GHz being preferred. The pressure in the reactor at the time of deposition is from about 20 to about 600 mtorr, with a pressure of from about 150 mtorr to about 250 mtorr being preferred.

The temperature of the substrate upon which the plasma comprised of the methyl acrylate starting material is deposited is maintained at a temperature that the person of ordinary skill in the art would recognize as suited for effecting deposition. A person of ordinary skill in the art would recognize that deposition at relatively low temperatures is a characteristic of PECVD processes per se. The substrate temperature can be maintained at the low-temperature ranges described above by using a liquid recirculator (not shown in FIG. 1) which is positioned adjacent to the reactor.

The gases used in forming the methyl acrylate film include a methyl acrylate, optionally hydrogen, and an inert gas such as He, Ne, Ar, or a mixture of inerts. These gases (i.e., methyl acrylate, inert gas, and optionally hydrogen) are mixed together prior to entering the reactor chamber.

In accordance with the present invention, the gas mixture employed in the formation of the methyl acrylate film comprises, by mass flow in standard cubic centimeters per minute (sccm), from about 50 to about 300 sccm methyl acrylate source, from about 0 to about 50 sccm hydrogen, and from 25 to about 100 sccm inert gas. More preferably, the gas mixture employed in the present invention comprises from about 150 to about 200 sccm methyl acrylate, from about 10 to about 25 sccm hydrogen, and from about 25 to about 75 sccm inert gas.

The deposition rate of the methyl acrylate film onto the IR transmissive material may vary depending on the conditions used to deposit the same. The thickness of the methyl acrylate film formed in the present invention may vary depending on the exact deposition conditions employed. Typically, however, the methyl acrylate film of the present invention has a deposited thickness of from about 0.02 to about 5 micron, with a deposited thickness of from about 0.03 to about 1 micron being more highly preferred.

The methyl acrylate film of the present invention is characterized as being IR transmissive, i.e., it is capable of transmitting IR energy of wavelengths of from about 0.1 to about 20 microns, preferably from about 1 to about 15 microns and most preferably from about 2 to about 12 microns. Additionally, the methyl acrylate film has sufficient adhesive properties with the underlying IR transmissive material; hence the methyl acrylate film does not delaminate from the IR transmissive material, and further exhibits good adhesion to an overlayer applied on top of the methyl acrylate film, such as an a-GeCₓ:H film that may be applied as a moisture barrier layer.

While the present invention has been particularly shown and described with respect to preferred embodiments thereof, it will be understood by those skilled in the art that the foregoing and other changes in forms and details may be made without departing from the spirit and scope of the present invention. It is therefore intended that the present invention not be limited to the exact forms and details described and illustrated, but fall within the scope of the appended Claims.

What is claimed is:

1. A method of forming an acrylate film on a surface of an infrared (IR) transmissive material, said method comprising the steps of:
depositing an acrylate film on a surface of an IR transmissive material by PECVD.

2. The method of claim 1 wherein the acrylate film is deposited by PECVD is effected by a device selected from the group consisting of a coupled parallel plate RF unit, a MW frequency plasma source, an inductively coupled plasma source, and expanding thermal plasma source.

3. The method of claim 1 wherein the acrylate is methyl acrylate.

4. The method of claim 1 wherein said substrate temperature is about 60° C. or less.

5. The method of claim 1 wherein said substrate temperature is from about 50° C. to about 55° C.

6. The method of claim 1 wherein said depositing includes a plasma generated from a gas mixture comprises a methyl acrylate source and an inert gas.

7. The method of claim 6 wherein said gas mixture further includes hydrogen.

8. The method of claim 7 wherein said mixture comprises from about 50 sccm to about 300 sccm methyl acrylate source, from about 20 sccm to about 50 sccm hydrogen, and from 25 sccm to about 100 sccm inert gas.

9. The method of claim 1 wherein said depositing is performed using an RF frequency of from about 20 kHz to about 2.45 GHz.

10. The method of claim 1 wherein said depositing is performed at a pressure of from about 20 mtorr to about 600 mtorr.

11. The method of claim 1 wherein said IR transmissive material is positioned on either a top electrode or a bottom electrode of said parallel plate reactor.

12. The method of claim 1 wherein said parallel plate reactor includes spaced-apart top and bottom electrodes wherein the top electrode is coupled to ground and the bottom electrode is coupled to an RF power supply.

13. The method of claim 1 wherein the IR transmissive material is a salt optic.

14. The method of claim 1 further comprised of the step of depositing a second film layer over the methyl acrylate film, wherein said depositing is performed at a substrate temperature of about 130° C. or less.

15. The method of claim 14 wherein the IR transmissive material is a salt optic.

16. The method of claim 14 wherein the second adhesion layer is selected from the group consisting of amorphous hydrogenated germanium carbon and silicone nitride.

17. The method of claim 16 wherein the IR transmissive material is a salt optic.

18. A method of forming an acrylate film on a surface of a salt optic, the method comprising the steps of: depositing an acrylate film on a surface of an IR transmissive material by PECVD.

19. The method of claim 18 wherein the acrylate film is deposited by PECVD is effected by a device selected from the group consisting of a coupled parallel plate RF unit, a MW frequency plasma source, an inductively coupled plasma source, and expanding thermal plasma source.

20. The method of claim 18 wherein the acrylate is methyl acrylate.

21. An optical transmissive component comprising:
an IR transmissive material; and
an acrylate film located atop a surface of the IR transmissive material,
wherein said methyl acrylate film is IR transmissive.

22. The method of claim 21 wherein the acrylate is methyl acrylate.

23. The optical transmissive component of claim 21 wherein said IR transmissive material is a salt optic.

24. The optical transmissive component of claim 23 wherein said salt optic is a potassium bromide salt optic.

25. The optical transmissive component of claim 21 wherein a second adhesion layer is selected from the group consisting of amorphous hydrogenated germanium carbon and silicone nitride.

26. The optical transmissive component of claim 21 wherein the second adhesion layer is selected from the group consisting of amorphous hydrogenated germanium carbon and silicone nitride.
